(19) United States
(12) Patent Application Publication
(10) Pub. No.: US 2011/0197451 A1
(43) Pub. Date: Aug. 18, 2011

(54) CUTTER FOR PRESS TOOL

(75) Inventor: Brian A. Mitchell, North Olmsted, OH (US)

(73) Assignee: EMERSON ELECTRIC CO., St. Louis, MO (US)

(21) Appl. No.: 12/707,134

(22) Filed: Feb. 17, 2010

(51) Int. Cl. B26D 3/16

(52) U.S. Cl. 30/92

(57) ABSTRACT

A cutting tool is disclosed which can be used in conjunction with a press tool, and in particular, a hydraulically operated hand held press tool. The cutting tool is selectively engaged with the press tool such that upon operation of the press tool, a cutting blade is pivoted past a wire or cable supporting cradle region to thereby cut or otherwise sever the wire or cable.

### FIELD OF THE INVENTION

The present invention relates to a cutting tool attachment for a press tool. The attachment is particularly useful for cutting wire and cable.

### BACKGROUND OF THE INVENTION

Handheld cutting tools such as for wire and cable, are known in many different styles, sizes, and configurations. Power operated or power assisted handheld cutting tools have been designed for reducing operator strain for applications in which large cutting forces are required and/or for performing a large quantity of cutting operations.

Electrically operated and hydraulically actuated portable press tools are known in the art. These tools typically use a hydraulic ram that provides a relatively large compressive force upon extension of the ram. A wide array of attachments can be used with such tools including for example pressing jaws to perform crimping operations upon pipe fittings.

Cutting attachments for such press tools are also known, such as described in U.S. Pat. No. 6,230,542. As far as is known, all currently known cutting attachments use a scissor hinge between one or more cutting elements. Although satisfactory in many respects, such cutting mechanisms require a relatively long stroke or ram extension in order to perform a cutting operation. This results in relatively slow cutting times. In addition, although typical press tools are able to deliver significant forces, for certain cutting applications it is desirable to provide a tailored force profile over the course of cutting.

Therefore, it would be desirable to provide a cutting tool that can be readily used with a press tool and which avoided the shortcomings of currently known cutting attachments.

### SUMMARY OF THE INVENTION

The difficulties and drawbacks associated with previously known cutting tools are overcome in the present cutting tool and related system.

In one aspect, the present invention provides a cutting tool adapted for selective attachment and operable engagement with a press tool having a powered displaceable ram. The cutting tool comprises a base member defining a support region for receiving and supporting a workpiece to be cut. The cutting tool also comprises a blade pivotally attached to the base member about a pivot axis. The blade defines a cutting region and is configured relative to the base member such that upon pivoting the blade about the pivot axis, at least a portion of the cutting region moves past the support region defined in the base member. The cutting tool also comprises a plunger operably connected to the blade. The plunger defines a proximal end that, upon attachment and engagement of the cutting tool to the press tool, contacts the ram of the press tool and transmits compressive force from the ram to the blade to thereby pivot the blade and move the cutting region defined by the blade past the support region of the base member. The plunger is operably connected to the blade at a location on the blade between the pivot axis and the cutting region of the blade.

In another aspect, the present invention provides a cutting tool configured for attachment and engagement with a powered hydraulically operated press tool. The cutting tool comprises a base member defining a support region for receiving and supporting a workpiece. The cutting tool also comprises a blade pivotably attached to the base member. The blade defines a cutting region. And, the cutting tool comprises a linearly displaceable plunger, the plunger defining a proximal end for attachment and contact with the press tool and an opposite distal end at which the plunger is operably engaged with the blade. Upon linear displacement of the plunger resulting from operation of the press tool, the blade is pivotally displaced about a pivot axis at which the blade is pivotably attached to the base member. The base member defines a channel within which the plunger is slidably received.

And in yet another aspect, the present invention provides a cutting tool having provisions for selective and operable engagement with a press tool. The cutting tool comprises a base member defining a support region for receiving and supporting a workpiece to be cut. The cutting tool also comprises a blade pivotably attached to the base member, the blade defining a cutting region. The cutting tool further comprises a linearly displaceable plunger. The plunger defines a proximal end for attachment and contact with the press tool and an opposite distal end. And, the cutting tool additionally comprises a roller member operably engaging the blade and the plunger. Upon linear displacement of the plunger resulting from operation of the press tool, the blade is pivotally displaced about a pivot axis at which the blade is pivotably attached to the base member.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a perspective view of a preferred embodiment cutting system in accordance with the present invention.

FIG. 2 is a perspective view of a preferred embodiment cutting tool in accordance with the invention.

FIG. 3 is a partial detailed schematic view of another preferred embodiment cutting tool illustrating the blade in a fully retracted position.

FIG. 4 is a partial detailed schematic view of the tool depicted in FIG. 3 illustrating the blade in a partially retracted position.

FIG. 5 is a partial detailed schematic view of the cutting tool shown in FIGS. 3-4 illustrating the blade in an extended position.

FIG. 6 is a perspective view of another preferred embodiment cutting tool in accordance with the invention.

FIG. 7 is a partial detailed perspective view of an end portion of yet another preferred embodiment cutting tool in accordance with the invention.

FIG. 8 is a perspective view of another preferred embodiment cutting tool in accordance with the invention.

FIG. 9 is a graph of ram force to ram displacement in a press tool during two cutting operations using a preferred embodiment cutting tool.

### DETAILED DESCRIPTION OF THE EMBODIMENTS

Generally, the present invention is directed to a cutting system and in particular, a press tool accessory for cutting items such as tubing or wire. The cutting tool accessory is particularly configured for use with hydraulically operated press tools. The cutting system comprises the cutting tool in combination with a press tool such as for example, a hydraulically operated press tool. The cutting tool is described in detail herein. And, representative examples of press tools suitable for use with the cutting tools are also described herein.

Preferably, the cutting tool includes a stationary support member or base member having a cradle region for supporting a tube or wire to be cut. The tool also preferably includes a cutting blade that is pivotally attached to the support member at a location generally rearward and below the cradle region. The blade is movable about its point of attachment, i.e. its pivot point, such that the blade sweeps past the cradle support region in an arc upon application of a compressive force to the blade. The cutting tool also includes a displacement or plunger member that is operably attached to the blade between the blade pivot point and a blade cutting region. The displacement or plunger member is configured for engagement with and transmitting the displacement force from, the hydraulic ram of the press tool. The cutting tool also features a guide slot in the stationary base member within which the plunger member travels during extension of the press tool ram. The guide slot stabilizes the plunger member during a cutting operation. A unique cam system is also preferably and optionally utilized in the present invention cutting tool. The cam system, depending upon its configuration, enables a particular force profile to be exhibited at the blade.

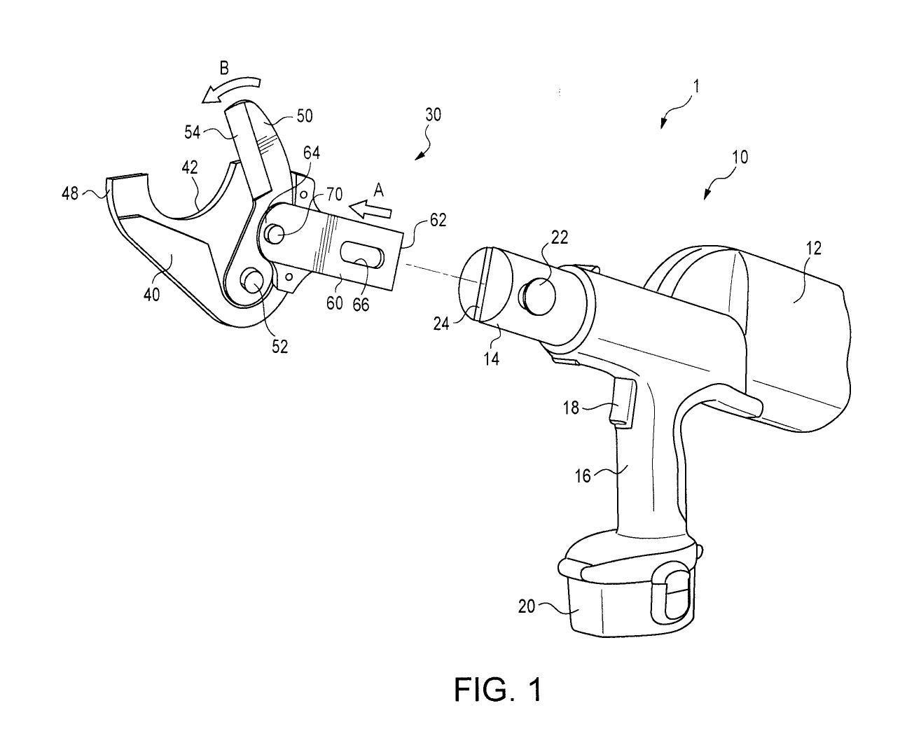

FIG. 1 illustrates a preferred embodiment powered cutting system 1 in accordance with the present invention. The system 1 comprises a press tool 10 and a cutting tool 30. The press tool 10 generally includes a housing 12 having a nose end 14 at which one or more accessories such as the cutting tool 30 are selectively and removably attached. The press tool 10 further includes a handle 16 for grasping the tool 10, a trigger 18 for activating the tool 10, and an optional on-board power source 20 such as a battery pack. It will be appreciated that the tool 10 can alternatively receive electrical power via one or more cords (not shown). The press tool 10 includes a mounting pin 22 and a receiving region 24 generally disposed along the nose end 14 of the tool 10. The mounting pin 22 and the receiving region 24 serve to engage and affix one or more accessories to the press tool 10 as known in the art. In accordance with the invention, the cutting tool 30 is provided for engagement and affixment to the press tool 10.

A wide array of press tools can be used for the press tool 10. For example, commercially available press tools RP 330 (corded or cordless versions) and RP 210-B from Ridge Tool Company of Elyria, Ohio can be used. The invention includes the use of other press tools having a selectively extendable hydraulic ram and suitably engageable with the cutting tools described herein.

The cutting tool 30 comprises a base member 40, a blade 50 pivotably attached to the base 40, a linearly displaceable plunger 60, and a roller 70 in operable engagement with the plunger 60 and the blade 50. Each of these components is described in greater detail as follows.

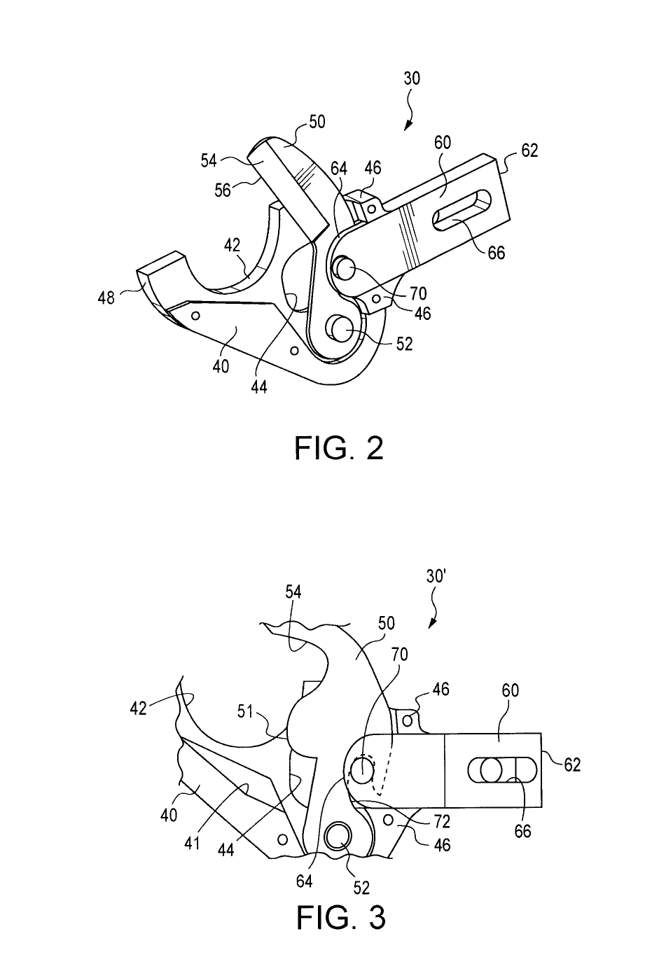

Referring to FIG. 2, the base member 40 includes a cradle support region 42 generally for supporting and retaining a workpiece or item to be cut by the cutting tool 30. Preferably, the support region 42 is in the form of an arcuate concave region. However, it will be appreciated that the support region 42 can be in a variety of other shapes and orientations depending upon the intended end use of the tool 30. The outer surface of the support region 42 can be textured or patterned to enhance its frictional characteristics to aid in gripping or retention of a workpiece, and particularly while undergoing cutting. The base member 40 also defines a channel 44 for receiving, guiding, and/or supporting the plunger 60 as the plunger is extended and retracted upon operation of the press tool 10. The channel 44 is accordingly sized and shaped to receive the plunger 60. This aspect is described in greater detail herein. The base member 40 preferably also includes one or more guides 46 for supporting and/or aligning the plunger 60 as the plunger 60 is linearly displaced as a result of extension or retraction of the powered ram of the press tool 10. Preferably, the base member 40 includes an upper guide 46 and a corresponding lower guide 46 as shown in FIG. 2. The base member 40 also includes a forwardmost or distal end 48. Various blade receiving structures and configurations can be provided at the distal end 48 for promoting blade stability during a cutting operation, as explained herein.

Referring further to FIGS. 1 and 2, the blade 50 is pivotably attached to the base member 40 by an attachment member 52. The attachment member 52 can be in various forms. A pin or axle form is preferred to provide pivotal movement of the blade 50 about the member 52. As noted, upon movement of the blade 50, the blade sweeps past the arcuate support region 42. The blade 50 moves within a plane generally parallel with the plane of the base member 40. The blade 50 defines a cutting region 54, which as will be appreciated may include a region of hardened material defining a cutting edge 56. A wide array of blade shapes, sizes, and configurations can be used. For example, a blade having a straight cutting edge can be used. Alternatively, a blade exhibiting an inwardly curved, i.e. concave, cutting edge can be used. Similarly, a blade exhibiting an outwardly curved, i.e. convex, cutting edge can be utilized. Serrated cutting edges are also contemplated. It will be appreciated that the present invention includes nearly any type of blade style.

The cutting tool 30 further includes a plunger 60. Plunger 60 serves to transmit force from a ram (not shown) in the press tool 10. Accordingly, the plunger 60 is linearly displaceable relative to the base member 40 and is preferably supported therein by the guide members 46. Most preferably, the plunger 60 is also received in the channel 44 defined in the base member 40. Specifically, the plunger 60 defines a proximal end 62 at which engagement to the press tool 10 is made, an opposite distal end 64, and an engagement slot 66 defined between the plunger ends 62 and 64. The engagement slot 66 extends through the plunger and is preferably oriented to extend parallel with the longitudinal axis of the plunger 60. Upon attachment of the cutting tool 30 to the press tool 10, the proximal end 62 of the plunger 60 is inserted in the receiving region 24 of the press tool 10 and the mounting pin 22 of the tool 10 is inserted within the engagement slot 66 defined in the plunger 60. The length and orientation of the slot 66 enables the plunger 60 to move relative to the base member 40. As will be appreciated, upon engagement between the cutting tool 30 and the press tool 10, and upon contact with an outwardly extending ram of the tool 10, the plunger 60 is forwardly displaced toward the distal end 48 of the base member 40. As the plunger 60 is linearly displaced, the blade 60 is pivoted about the member 52 to thereby move the cutting region 54 of the blade alongside and past a workpiece (not shown) residing in the support region 42.

The plunger 60 is preferably operably attached to the blade 50 by the roller 70. As previously noted, the cutting tool preferably and optionally includes a cam assembly for achieving a particular force or displacement profile at the blade 50. The preferred cutting tool 30 includes a representative cam assembly by use of the roller 70 and a corresponding cam surface 72 (not shown in FIGS. 1 and 2) defined in the blade 60. This particular cam assembly is described in conjunction with FIGS. 3-5 herein. Although the use of a roller and cam assembly is preferred for attaching the blade 50 to the plunger 60, a pin attachment is also contemplated. That is, a pin member could be used in place of the roller 70 without any cam surface. In this alternative embodiment, the pin member extends through apertures extending in the plunger 60 and the blade 50.

Referring to FIG. 1, upon engagement between the cutting tool 30 and the press tool 10, upon extension of the powered ram, the plunger 60 is displaced in the direction of arrow A. As a result of the operable engagement between the plunger 60 and the blade 50, the blade is pivoted about member 52 in the direction of arrow B.

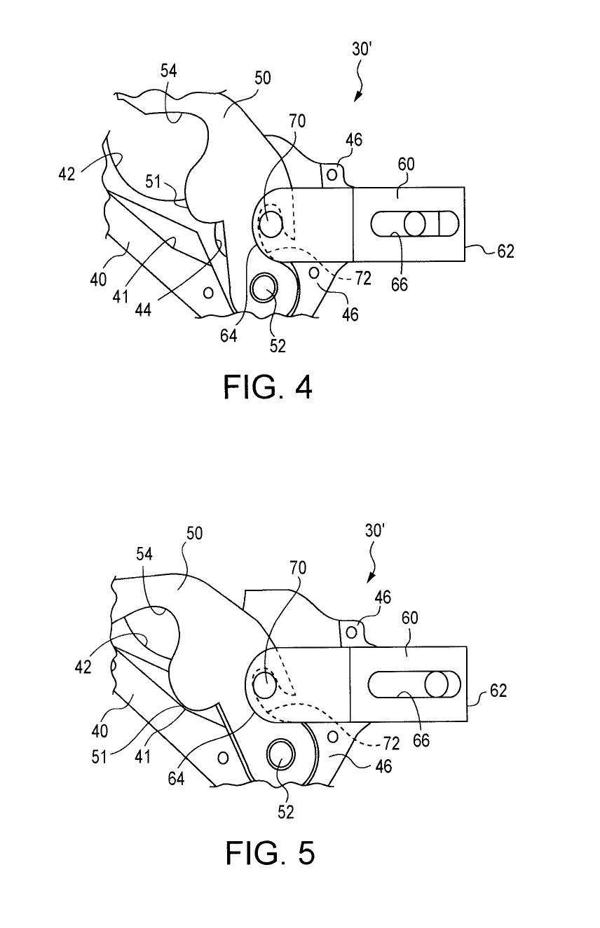

FIGS. 3-5 illustrate another preferred embodiment of the cutting tool. In this embodiment designated as 30′, the configuration of the blade 50 is different than that of blade 50 depicted in FIGS. 1-2, and a cam surface 72 defined by the blade 50 is illustrated in dashed lines for ease in describing such. The blade 50 in the cutting tool 30′ of FIGS. 3-5 is depicted as having an inwardly curved cutting edge at region 54. Specifically, FIGS. 3-5 illustrate the cutting tool 30′ in three different positions or states through which the tool passes during a typical cutting operation. FIG. 3 illustrates the blade 50 and the plunger 60 in a fully retracted position. The roller 70 is disposed within a cam slot defined by the cam surface 72 of the blade 50. In the particular configuration of the cutting tool 30′ shown in FIGS. 3-5, upon retraction of the plunger 60 and the blade 50, the roller 70 is preferably positioned rearward of the pivotal attachment member 52. Upon extension of the press tool ram (not shown), the plunger 60 is forwardly displaced thereby resulting in pivoting movement of the blade 50 about the member 52 and toward the support region 42 of the base member 40. This position of intermediate extension of the plunger 60 and the blade 50 is depicted in FIG. 4. As the plunger 60 is further forwardly displaced as shown in FIG. 5, the cutting region 54 of the blade is swept past the support region 42 of the base member 40. At the end of forward linear displacement of the plunger 60, one or more stop surfaces of the blade 50 may contact corresponding stop surfaces in the base member 40. For example, the blade 50 can be provided with a stop surface 51 and the base member 40 can be provided with a stop surface 41. Upon full extension of the blade 50, the stop surfaces 41 and 51 contact one another. And, for the particular configuration of the tool 30′ depicted in FIGS. 3-5, upon full extension of the plunger 60 and the blade 50, the roller 70 or at least its center axis, is positioned forward that of the pivotal attachment member 52 or the center axis of that member 52. It will be appreciated that in no way is the invention limited to this particular configuration. Instead, the invention includes a wide range of configurations and arrangements between the roller 70 and the pivotal attachment member 52 during extension of the plunger 60 and the blade 50. It is preferred that the plunger 60 is displaced in a direction parallel and most preferably collinearly, with its longitudinal axis.

A significant feature of the incorporation of this cam feature in the cutting tools described herein is that selection of the cam profile or configuration enables one to tailor the travel and force available from the tool to provide the output needed in order to cut or modify the workpiece. Furthermore, the cam profile as described herein results in a relationship in which the extent of blade movement is greater than tool stroke. Since the press tool is capable of outputting significantly more force than is typically required for a cutting operation, the cam enables strategic cutting motion within the stroke limitations of the press tool.

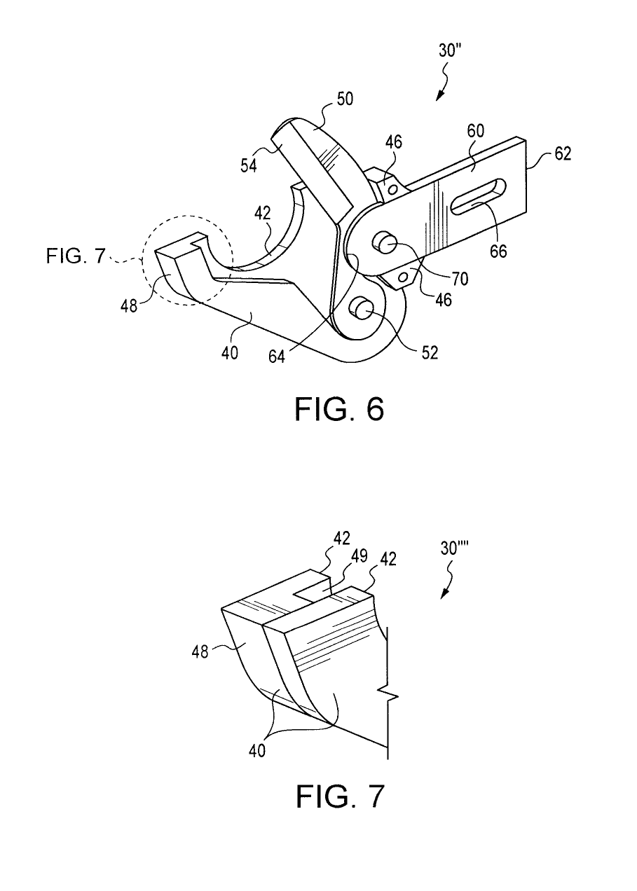

FIG. 6 is a perspective view of another preferred embodiment cutting tool 30″ in accordance with the invention. In this embodiment designated as 30″, the distal or forward end 48 of the tool is provided with a reinforced region. This region may be provided by incorporating one or more thickened or strengthened supports along the distal end 48. This is preferred as such reinforced regions serve to promote cutting consistency by providing greater support for the blade 50 upon extension of the blade 50, particularly at a location of the blade travel at which a final phase of cutting occurs.

FIG. 7 illustrates yet another preferred embodiment cutting tool 30′″ featuring a base member 40 having a distal end 48 that defines a blade capture region 49. The capture region 49 serves to provide support for the blade 50 upon full extension and to present or at least reduce lateral blade movement toward the latter stages of a cutting operation. The reference to lateral blade movement refers to blade movement out of the plane within which the base member 40 generally extends and the plane within which the blade 50 moves during a cutting operation.

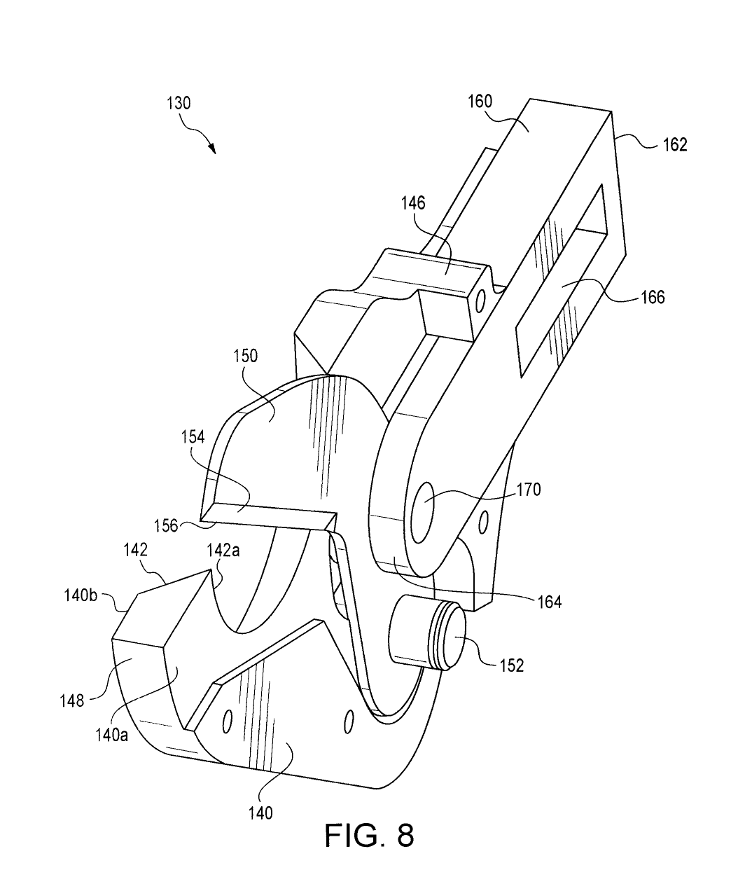

FIG. 8 is a perspective view of yet another preferred embodiment cutting tool 130 in accordance with the invention. The tool 130 generally comprises a base member 140 having a blade 150 pivotally attached thereto by a pivot pin 152. The blade 150 defines a cutting region 154 and a cutting edge 156. The blade 150 is engaged with a linearly displaceable plunger 160 having a proximal end 162 and an opposite distal end 164. A slot 166 is defined in the plunger. The plunger 160 is affixed to the blade 150 via a roller 170 or other comparable member. The base member 140 may include a cutting region 142 that defines a cutting edge 142a. As evident in the illustration, the cutting region 142 preferably includes an inclined or sloped surface that extends at an angle less than 90° or greater than 90° with respect to faces 140a and 140b. For example, in the configuration depicted in FIG. 8, the surface of the cutting region 142 extends at an angle of approximately 45° with respect to face 140a of the base member 140, and about 135° with respect to face 140b. It will be appreciated that in no way is the invention limited to this particular configuration. This configuration, i.e. the provision of two cutting regions and two cutting edges, may be preferred for many applications.

A typical cutting operation using the cutting tool of the invention is as follows. The cutting tool 30 is attached to a press tool such as illustrated in FIG. 1 by pulling the mounting pin 22 laterally outward from the nose end 14 of the tool 10. Next, the proximal end 62 of the plunger 60 of the tool 30 is inserted within the receiving region 24 of the nose end 14 of the tool 10. Upon appropriate positioning of the cutting tool 30 relative to the press tool 10, the mounting pin 22 (typically spring biased to return to its default position) is released so as to insert and extend through the engagement slot 66 defined in the plunger 60. Upon attachment of the cutting tool 30 to the press tool 10, a workpiece such as a cable or wire is positioned in the support region 42. The press tool 10 is then operated to effect extensioning of its ram. Upon contact between the ram and the proximal end 62 of the plunger 60, linear displacement of the plunger 60 is initiated. As the ram continues to be extended, the plunger 60 is displaced within the channel 44 defined in the base member 40 and generally in a direction toward the distal end 48 of the member 40. Displacement of the plunger 60 in conjunction with the cam system including the roller 70 and the cam surface 72 along the blade 50, causes pivotal movement of the blade 50 about the member 52. As movement of the ram and plunger 60 continue, the blade 50 is swept past the support region 42 of the base member, thereby severing or cutting the workpiece disposed thereon.

Although it is generally preferred to utilize a cam configuration in the cutting tool, it will be appreciated that the invention includes other assemblies. For example, a fixed roller assembly could be incorporated in the blade which would be operably engaged with a vertical slot defined in the plunger or displacement member.

It will be understood that although the preferred embodiment cutting tool and system have been described with reference to cutting wire or cable, in no way is the invention limited to such. Instead or in addition to wire and cable, tubing such as plastic (e.g. PVC), metal, and composite tubing; pipes including steel, cast iron, and copper; rolled or cylindrical members such as reinforcing or structural support members; and packaging or retention members such as straps, chains, or the like, can all be cut or severed using the present invention.

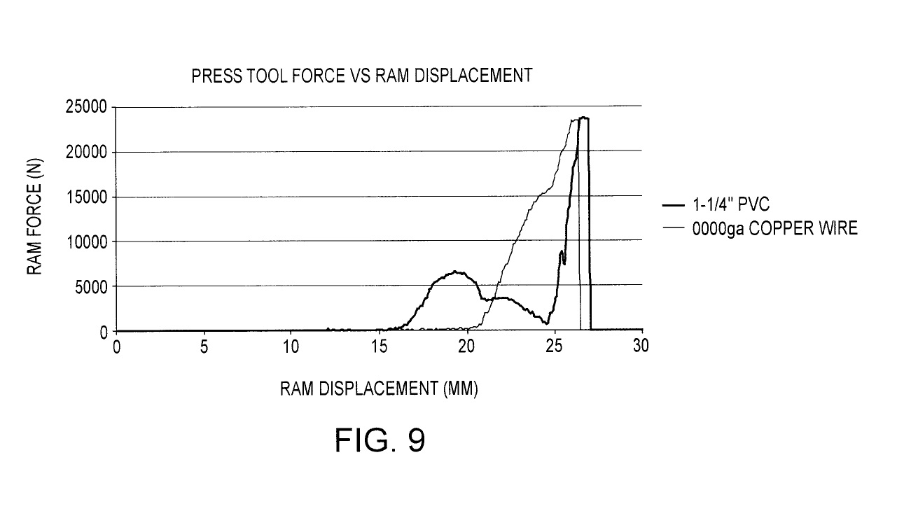

FIG. 9 is a graph of force (in Newtons) from a press tool ram measured as a function of ram displacement (in mm) when cutting two samples using a preferred embodiment cutting tool and a commercially available press tool from Ridge Tool Company. One sample was a 1.25 inch PVC pipe. The other sample a 0000 gauge copper wire. This graph illustrates the disparity in force profiles in cutting different objects formed from different materials.

Many other benefits will no doubt become apparent from future application and development of this technology.

All patents, published applications, and articles noted herein are hereby incorporated by reference in their entirety.

It will be understood that any one or more feature or component of one embodiment described herein can be combined with one or more other features or components of another embodiment. Thus, the present invention includes any and all combinations of components or features of the embodiments described herein.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

those skilled in the art without departing from the principle and scope of the invention, as expressed in the appended claims.

What is claimed is:

1. A cutting tool adapted for selective attachment and operable engagement with a press tool having a powered displaceable ram, the cutting tool comprising:
a base member defining a support region for receiving and supporting a workpiece to be cut;
a blade pivotally attached to the base member about a pivot axis, the blade defining a cutting region, the blade configured relative to the base member such that upon pivoting the blade about the pivot axis, at least a portion of the cutting region moves past the support region defined in the base member; and
a plunger operably connected to the blade, the plunger defining a proximal end that, upon attachment and engagement of the cutting tool to the press tool, contacts the ram of the press tool and transmits compressive force from the ram to the blade to thereby pivot the blade and move the cutting region defined by the blade past the support region of the base member, wherein the plunger is operably connected to the blade at a location on the blade between the pivot axis and the cutting region of the blade.

2. The cutting tool of claim 1 wherein the plunger is linearly displaceable and, upon contact with the ram and transmission of compressive force from the ram, is linearly displaced along its longitudinal axis.

3. The cutting tool of claim 1 wherein the base member includes at least one outwardly projecting guide in contact with the plunger to thereby stabilize the plunger during linear displacement thereof.

4. The cutting tool of claim 3 wherein the base member includes an upper guide and a lower guide, the plunger being disposed between the upper guide and the lower guide.

5. The cutting tool of claim 1 wherein the plunger defines a distal end opposite the proximal end, and the base member defines a channel sized and configured to receive the distal end of the plunger.

6. The cutting tool of claim 1 wherein the plunger defines a longitudinal engagement slot extending through the plunger which upon attachment to the press tool, receives a mounting pin of the press tool.

7. The cutting tool of claim 1 wherein the blade is pivotally positionable between (i) an extended position in which the cutting region of the blade is positioned alongside the support region of the base member, and (ii) a retracted position in which the cutting region of the blade is spaced from the support region and the support region is accessible for receiving and supporting a workpiece.

8. The cutting tool of claim 7 wherein the base member defines a distal end, the distal end including a blade capture region having at least one surface for contacting a distal end of the blade upon pivoting of the blade to position (i).

9. The cutting tool of claim 1 wherein the plunger is operably connected to the blade by a cam surface defined along a region of the blade between the pivot axis and the cutting region, an aperture defined in a distal end of the plunger, and a roller extending through the aperture and contacting the cam surface.

10. The cutting tool of claim 1 wherein the support region of the base member defines a cutting region including a surface that extends at an angle of less than 90° to a face of the base member.

11. A cutting tool configured for attachment and engagement with a powered hydraulically operated press tool, the cutting tool comprising:
a base member defining a support region for receiving and supporting a workpiece;
a blade pivotably attached to the base member, the blade defining a cutting region;
a linearly displaceable plunger, the plunger defining a proximal end for attachment and contact with the press tool and an opposite distal end at which the plunger is operably engaged with the blade, wherein upon linear displacement of the plunger resulting from operation of the press tool, the blade is pivotally displaced about a pivot axis at which the blade is pivotably attached to the base member,
wherein the base member defines a channel within which the plunger is slidably received.

12. The cutting tool of claim 11 wherein the base member includes at least one outwardly projecting guide contacting the plunger.

13. The cutting tool of claim 11 wherein the blade is pivotably positionable between (i) an extended position in which the blade is positioned alongside the support region of the base member and (ii) a retracted position in which a distal end of the blade is spaced from the support region and the support region is accessible for receiving and supporting a workpiece.

14. The cutting tool of claim 13 wherein the base member defines a distal end, the distal end including a blade capture region having at least one surface for contacting a distal end of the blade upon pivoting of the blade to position (i).

15. The cutting tool of claim 11 wherein the plunger is operably connected to the blade at a location on the blade between the pivot axis and the cutting region of the blade.

16. The cutting tool of claim 11 wherein the plunger is operably connected to the blade by a cam surface defined along a region of the blade between the pivot axis and the cutting region, an aperture defined in a distal end of the plunger, and a roller extending through the aperture and contacting the cam surface.

17. The cutting tool of claim 11 wherein the support region of the base member defines a cutting region including a surface that extends at an angle of less than 90° to a face of the base member.

18. A cutting tool having provisions for selective and operable engagement with a press tool, the cutting tool comprising:
a base member defining a support region for receiving and supporting a workpiece to be cut;
a blade pivotably attached to the base member, the blade defining a cutting region;
a linearly displaceable plunger, the plunger defining a proximal end for attachment and contact with the press tool and an opposite distal end;
a roller member operably engaging the blade and the plunger, wherein upon linear displacement of the plunger resulting from operation of the press tool, the blade is pivotally displaced about a pivot axis at which the blade is pivotably attached to the base member.

19. The cutting tool of claim 18 wherein the blade defines a cam surface which the roller contacts during engagement between the plunger and the blade.

20. The cutting tool of claim 19 wherein the cam surface located between the pivot axis and the cutting region of the blade.

21. The cutting tool of claim 18 wherein the roller member extends at least partially through an aperture defined in a distal end of the plunger.

22. The cutting tool of claim 18 wherein the base member defines a channel within which the plunger is slidably received.

23. The cutting tool of claim 18 wherein the support region of the base member defines a cutting region including a surface that extends at an angle of less than 90° to a face of the base member.
